(19) United States
(12) Patent Application Publication
(10) Pub. No.: US 2002/0038762 A1
(43) Pub. Date: Apr. 4, 2002

(54) Solid-state ion selective electrodes and methods of producing the same

(75) Inventors: Irina Eventov, Haifa (IL); Shai Nimri, Kibbutz Nir David (IL)

Correspondence Address: Mark Friedman LTD, C/O Bill Polkinghorn- Discovery Dispatch, 9003 Florin Way, Upper Marlboro, MD, 20772, US

(73) Assignee: ADVANCED MONITORING SYSTEMS LTD.

(21) Appl. No.: 09/777,852

(22) Filed: Feb. 7, 2001

Related U.S. Application Data
(63) Continuation-in-part of application No. 09/677,174, filed on Oct. 2, 2000.

(51) Int. Cl. G01N 27/414

(52) U.S. Cl. 204/418

(57) ABSTRACT

The present invention relates to solid-state ion selective electrodes (ISEs), methods of producing same and devices containing same. The electrodes include: (a) an internal reference element which includes a homogenous conducting body; (b) a solid contact which includes a hydrophobic polymer, an ionophore and particles of conductive material and (c) an ion selective membrane which includes a hydrophobic polymer and an ionophore. The particles of conductive material are dispersed throughout the hydrophobic polymer of the solid contact.

The method includes a the steps of: (a) providing an internal reference element which includes a homogenous conducting body; (b) preparing an emulsion which includes a hydrophobic polymer, an ionophore, particles of conductive material, and an organic solvent; (c) applying emulsion to the reference element and allowing the organic solvent to evaporate thereby causing a residue of the emulsion to form a solid contact adhering the reference element; (d) preparing a solution which includes ahydrophobic polymer, an ionophore and an organic solvent; and (e) applying the solution the solid contact and allowing the organic solvent to evaporate to form an ion selective membrane adhering the solid contact.

This application is a continuation in part of U.S. Pat. No. 09/677,174, which is currently pending.

### FIELD AND BACKGROUND OF THE INVENTION

The present invention relates to solid-state ion selective electrodes (ISEs), methods of producing same and devices containing same. More particularly, the present invention relates to solid-state ISEs which exhibit improved performance, enhanced long-term stability of potential, are amenable to miniaturization, are inexpensive and producable by a simplified method of manufacture.

The need for simple and precise determination of ionic activity in solution has long been recognized. This need exists in many settings, including clinical, industrial and environmental laboratories. For example, the blood concentration of physiological electrolytes, e.g. potassium (K⁺) or sodium (Na⁺), or of the mental drug lithium (Li⁺), are known to have major medical significance [1]. The measurement of specific ion concentration in multicomponent solution is commonly based on the technology of ion selective electrodes. This technology has been on the focus of scientific interest during the last decades [2].

The mode of action of ISEs and similar ion sensors is briefly described herein.

Typically, an ISE is immersed together with an external reference electrode in a test solution. The electric potential developed between the ISE and the reference electrode is measured by a voltmeter. Since this potential is proportional to the logarithm of the detected ion activity, the required concentration may be directly calculated from the measured potential.

An ISE demand two components in order to function.

The first required component of an ISE is an ion selective layer, which contacts the test solution. The ion selective layer is typically a polymeric membrane that contains ionophore molecules. For purposes of this specification and the accompanying claims, an “ionophore” is defined as a compound that specifically binds an ion to be detected.

The second required component of an ISE is an internal reference element, which includes a conductive substance used for electric voltage indication. Internal reference element may be made of a single homogenous body, such as a metal wire or a conducting graphite mass. Internal reference element may alternately be composed of heterogeneous configuration, usually in order to form a redox couple and thus stabilize its potential. For example, silver wire coated with AgCl may be employed. Applying such a coating demands chemical or electrochemical processes.

Historically, ISEs contained aqueous electrolytic filling solution, as an intermediate layer between the membrane and the reference element. In such a case, test solution ions are complexed by ionophore molecules, and partially extracted by the filling solution without their counter ion. The resulting electric potential at the membrane-solution interface is detected by the system. Although such electrodes are currently in use, they have several inherent drawbacks. The presence of the aqueous layer makes them mechanically complicated, expensive and difficult to miniaturize. In addition, gradual electrolyte leakage and dehydration shortens their lifetime, and they cannot withstand high pressure conditions.

In order to address some of these limitations, solid-state ISE systems have been developed. Coated wire electrodes (CWEs) are the basic solid-state ISE. In a CWE, the ion selective layer is directly attached to the conductive element. Similarly, a configuration in which the indication element is a semiconductor may be employed to form an ion selective field effect transistor (ISFET). However, such designs tend to exhibit unstable potential, due to the lack of a well-defined interface between the electroactive membrane and the internal reference. Additionally, these patterns exhibit drift of potential, which represents a serious drawback. Therefore, the use of CWEs requires frequent calibration of the ion-sensing device, which is inconvenient. Such continuous potential drift also limits the useful life of ISEs.

These problems are compounded by the fact that ISEs are increasingly operated by non-skilled users, e.g. in point-of-care (POC) and home-use medical test devices [3]. For these applications, non-drifting, highly stable and durable electrodes are required. In addition, ISEs for such applications should have rapid response time and relatively small size. These growing markets also demand inexpensive products, i.e., the electrodes should be manufactured from low-cost raw materials and by simple methods, which are suitable for mass production.

Several attempts have been made to produce solid-state ISEs and ISFETs that comply with the above requirements and devoid of the above limitations.

One strategy was the addition of various components to the membrane formula of a CWE. For example, conjugated polymers or organic charge carriers (“fortiophores”) were added to the membrane compositions [4, 5]. However, the minimum drift rate reported in these U.S. Patents was 0.8 mV/day, or 24 mV/month. According to the Nernst equation, change of 58 mV represents a difference of order of magnitude in the concentration of mono-valent ions at 20° C. Therefore, a tenfold difference in measured ion concentration is expected to result in these electrodes during 2.5 months of use without calibration. Such a level of inaccuracy is clearly unacceptable.

Another strategy is the construction of a solid intermediate layer (solid contact) between the membrane and the reference element. Initially, compositions of solid contact systems were based on a dry form of water-soluble salts [6, 7]. However, these salts are extremely hydrophilic. As a result, even when a hydrophobic membrane is applied, such electrodes tend to gradually absorb water into their hydrophilic inner parts. This causes swelling and changes in their electrical behavior, which is reflected e.g. in potential drift.

Therefore, in order to create ISEs with higher long-term stability, a solid contact of a hydrophobic nature was attempted.

One solid contact of a hydrophobic nature found in the prior art includes an ionic bridge from a mixture of inorganic salts and hydrophobic conducting resin [8]. This resin was made from a curable polymer and conductive powder. The polymeric material necessarily had large adhesion strength (e.g. phenolic polymer). However, curing of the polymer required heat treatment at high temperatures (e.g. 150° C.). The selective layer in this case was necessarily a solid electrolyte; as an example, a NASICON ceramic disk was mounted and sealed with epoxy resin, to form a sodium selective layer.

Alternately, a porous graphite rod dipped in a hydrophobic organic phase containing ion carriers may be used as a solid contact [9]. The described ISEs required a metallic reference element with a metallic salt coating, in order to stabilize the system potential. According to these teachings, the preparation procedure included anodizing silver wire to form an Ag/AgCl reference element, drilling a hole in the graphite porous body, tightly placing the element in the hole, and dipping the formed mass in an organic solution for several hours. Even after this relatively complicated manufacture process, these electrodes exhibited a potential drift of about 15 mV in 27 days.

There is thus a widely recognized need for, and it would be highly advantageous to have, solid-state ion selective electrodes that comply with the above requirements and devoid of the above limitations.

### SUMMARY OF THE INVENTION

According to one aspect of the present invention there is provided an improved solid-state ion selective electrode. The electrode includes: (a) an internal reference element, the reference element including a single homogenous conducting body; (b) a solid contact, the solid contact including a first hydrophobic polymer, a first ionophore of an ion to be detected and a non-ordered plurality of particles of conductive material, wherein the particles of conductive material are dispersed throughout the first hydrophobic polymer; and (c) an ion selective membrane, the ion selective membrane including a second hydrophobic polymer and a second ionophore of the ion to be detected.

According to another aspect of the present invention there is provided a method of producing an improved solid-state ion selective electrode. The method includes the steps of: (a) providing an internal reference element, the reference element including a single homogenous conducting body; (b) preparing a homogenous emulsion, the emulsion including a first hydrophobic polymer, a first ionophore of an ion to be detected, a plurality of particles of conductive material, and a first organic solvent; (c) applying the homogeneous emulsion to a surface of the reference element and allowing the first organic solvent to evaporate thereby causing a residue of the homogeneous emulsion to form a solid contact adhering to at least a portion of the reference element; (d) preparing a homogenous solution, the solution including a second hydrophobic polymer, a second ionophore of the ion to be detected and a second organic solvent; and (e) applying the solution to at least a portion of the solid contact and allowing the second organic solvent to evaporate to form an ion selective membrane adhering to at least a portion of the solid contact.

According to further features in preferred embodiments of the invention described below, the solid contact further includes a solid contact plasticizer.

According to still further features in the described preferred embodiments the solid contact plasticizer is selected from the group consisting of 2-nitrophenyl octyl ether and bis(1-butylpentyl) adipate.

According to still further features in the described preferred embodiments the membrane further includes a membrane plasticizer.

According to still further features in the described preferred embodiments the membrane plasticizer is selected from the group consisting of 2-nitrophenyl octyl ether and bis(1-butylpentyl) adipate According to still further features in the described preferred embodiments at least one item selected from the group consisting of the solid contact and the membrane further includes at least one additive.

According to still further features in the described preferred embodiments the at least one additive includes potassium tetrakis-(4-chlorophenyl) borate.

According to still further features in the described preferred embodiments the homogenous conductive body includes a compressed graphite rod.

According to still further features in the described preferred embodiments at least one item selected from the group consisting of the first hydrophobic polymer and the second hydrophobic polymer includes polyvinylchloride (PVC).

According to still further features in the described preferred embodiments the ion to be detected is selected from the group consisting of sodium (Na⁺), potassium (K⁺) and lithium (Li⁺).

According to still further features in the described preferred embodiments the first ionophore and the second ionophore are selected from the group consisting of the sodium ionophore 4-tert-butylcalix(4)arene-tetraacetic acid tetraethyl ester, the potassium ionophore 2-dodecyl-2-methyl-1,3-propandiyl bis(N-(5′-nitro(benzo-15-crown-5)-4′-yl)carbamate, and the lithium ionophore N,N,N′,N′,N″,N″-hexacyclohexyl-4,4′,4″-propylidynetris(3-oxabutyramide).

According to still further features in the described preferred embodiments the conductive material includes graphite, and the particles of the conductive material include graphite powder.

According to still further features in the described preferred embodiments the method further includes the step of: (f) placing a stripped end of a shielded electric wire within a plastic tube, the plastic tube functioning as the electrode body.

According to still further features in the described preferred embodiments the method further includes the step of: (g) tightly inserting the homogenous conductive body of the reference element into the plastic tube so that an electric contact with the stripped end of the shielded electric wire is formed.

According to still further features in the described preferred embodiments the step of applying the homogeneous emulsion to the surface of the reference element is conducted within the plastic tube so that the solid contact is formed therein.

According to still further features in the described preferred embodiments the step of applying the homogeneous solution to the surface of the solid contact is conducted within the plastic tube so that the membrane is formed therein.

According to still further features in the described preferred embodiments at least one item selected from the group consisting of the first organic solvent and the second organic solvent is tetrahydrofurane (THF).

According to still further features in the described preferred embodiments the step of allowing the first organic solvent to evaporate and the step of allowing the second organic solvent to evaporate are each independently conducted at a low temperature. The low temperature is preferably in the range of 4 to 100 degrees centigrade, more preferably in the range of 10 to 50 degrees centigrade and most preferably in the range of 14 to 28 degrees centigrade.

According to still further features in the described preferred embodiments the single homogeneous conducting material includes graphite.

According to still further features in the described preferred embodiments at least one item selected from the group consisting of the emulsion and the solution further includes at least one additive.

The present invention successfully addresses the shortcomings of the presently known configurations by providing solid-state ion selective electrodes (ISEs) which exhibit high long-term stability of potential in comparison to prior art electrodes, and by providing methods of producing the same which are simple and economical in comparison to prior art methods.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a cross sectional view of an ISE according to the present invention.

FIG. 2 depicts calibration curves of a sodium electrode according to the present invention.

FIG. 3 depicts calibration curves of a lithium electrode according to the present invention.

FIG. 4 depicts measurements of K⁺ with a potassium electrode according to the present invention in the presence NaCl.

FIG. 5 depicts continuous measurement with a lithium electrode according to the present invention

FIG. 6 depicts measurements with a sodium electrode according the present invention during a 37 day period.

FIG. 7 depicts measurements with a potassium electrode according to the present invention during a 31 day period.

FIG. 8 depicts calibration curves of a potassium electrode according to the present invention when new and after 10 months of use and more than 1000 measurements.

FIG. 9 is a flow diagram depicting method steps of methods according to the present invention.

### DESCRIPTION OF THE PREFERRED EMBODIMENTS

The principles and operation of solid-state ion selective electrodes (ISEs), methods of producing same and devices containing same according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

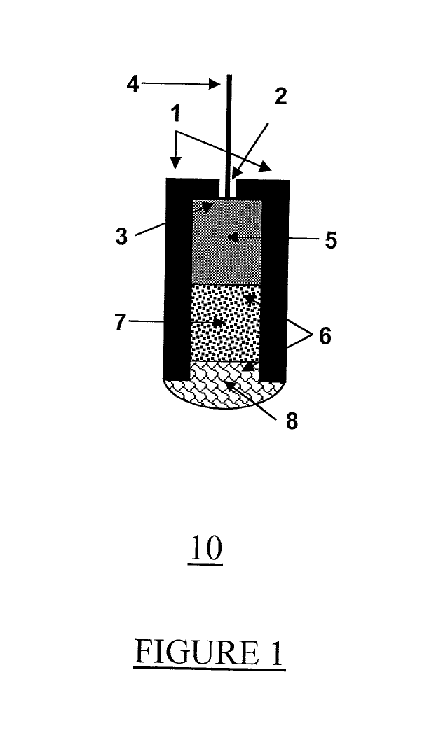

FIG. 1 depicts an improved solid-state ion selective electrode 10 according to the present invention. Electrode 10 includes an internal reference element 5, which includes a single homogenous conducting body. The homogenous conductive body of reference element 5 may, in some cases, include a compressed graphite rod. Electrode 10 further includes a solid contact 7, which includes a first hydrophobic polymer, a first ionophore of an ion to be detected and a non-ordered plurality of particles of conductive material. The particles of conductive material are dispersed throughout the first hydrophobic polymer within solid contact 7. Examples of suitable particles of conductive material include, but are not limited to, graphite powder and carbon black. Alternately or additionally, a powdered conductive metal, such as iron, copper or gold, might be employed as conductive particles. Electrode 10 further includes an ion selective membrane 8 which includes a second hydrophobic polymer and a second ionophore of the ion to be detected. Either the first hydrophobic polymer or the second hydrophobic polymer may include PVC.

According to additional preferred embodiments of electrode 10, either solid contact 7 or membrane 8 or both may further include a solid contact plasticizer such as, for example, 2-nitrophenyl octyl ether or bis(1-butylpentyl) adipate. Alternately or additionally, either solid contact 7 or membrane 8 or both may further include at least one additive such as, for example, potassium tetrakis-(4-chlorophenyl) borate.

Depending upon the composition of electrode 10, the ion to be detected may be, for example, sodium (Na⁺), potassium (K⁺) or lithium (Li⁺). Examples of ionophores are crown ethers and other compounds that are known as selective ion carriers. Specifically suited for use as either the first ionophore or the second ionophore or both are the sodium ionophore 4-tertbutylcalix(4)arene-tetraacetic acid tetraethyl ester, the potassium ionophore 2-dodecyl-2-methyl-1,3-propandiyl bis(N-(5′-nitro(benzo-15-crown-5)-4′yl)carbamate, and the lithium ionophore N,N,N′,N′,N″,N″-hexacyclohexyl-4,4′,4″-propylidynetris(3-oxabutyramide).

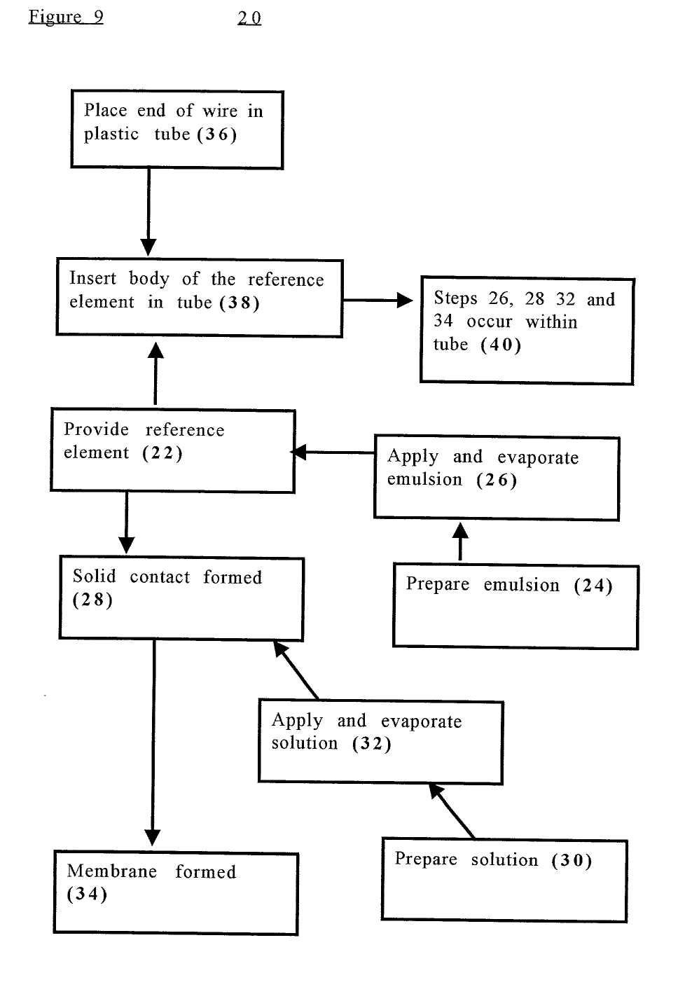

The present invention is further embodied by a method 20 (FIG. 9) of producing an improved solid-state ion selective electrode 10. Method 20 includes the step of providing 22 an internal reference element 5 as described hereinabove. Reference element 5 may include a single homogeneous conducting material, for example graphite. In this case the single homogeneous conducting body may be, for example, a graphite rod.

Method 20 further includes the step of preparing 24 a homogenous emulsion. The emulsion includes a first hydrophobic polymer, a first ionophore of an ion to be detected, a plurality of particles of conductive material, and a first organic solvent. According to preferred embodiments of method 20, the conductive material includes graphite, and the particles of the conductive material include graphite powder. Method 20 further includes the step of applying 26 the emulsion to a surface of reference element 5 and allowing the first organic solvent to evaporate. This causes a residue of the emulsion to form 28 a solid contact 7 adhering to at least a portion of reference element 5. Method 20 further includes the step of preparing 30 a homogenous solution including a second hydrophobic polymer, a second ionophore of the ion to be detected and a second organic solvent. According to preferred embodiments of the invention either the first organic solvent or the second organic solvent or both may include THF. Alternately or additionally, other volatile organic fluids may be employed. According to additional preferred embodiments of method 20, either the emulsion or the solution or both may further include at least one additive as described hereinabove. Method 20 further includes the step of applying 32 the solution to at least a portion of solid contact 7 and allowing the second organic solvent to evaporate to form 34 an ion selective membrane adhering to at least a portion of solid contact 7. According to preferred embodiments of method 20, the step of allowing the first organic solvent to evaporate and the step of allowing the second organic solvent to evaporate are each independently conducted at a low temperature. The low temperature is preferably in the range of 4 to 100 degrees centigrade, more preferably in the range of 10 to 50 degrees centigrade and most preferably in the range of 14 to 28 degrees centigrade. This means that, according to many embodiments of method 20, production of electrode 10 is conducted at room temperature. Evaporation times according to the present invention vary but are preferably in the range of 1 to 10 minutes.

In some cases, method 20 may further include the step of placing 36 a stripped end 3 of a shielded electric wire 4 within a plastic tube 1 which functions as the electrode body. Method 20 may further include the step of tightly inserting 38 the homogenous conductive body of reference element 5 into plastic tube 1 so that an electric contact with stripped end 3 of wire 4 is formed. Therefore, according to preferred embodiments 40 of method 20 the step of applying 26 the homogeneous emulsion to the surface of reference element 5 is conducted within tube 1 so that solid contact 7 is formed therein and the step of applying 32 the homogeneous solution to the surface of solid contact 7 is conducted within tube 1 so that membrane 8 is formed therein.

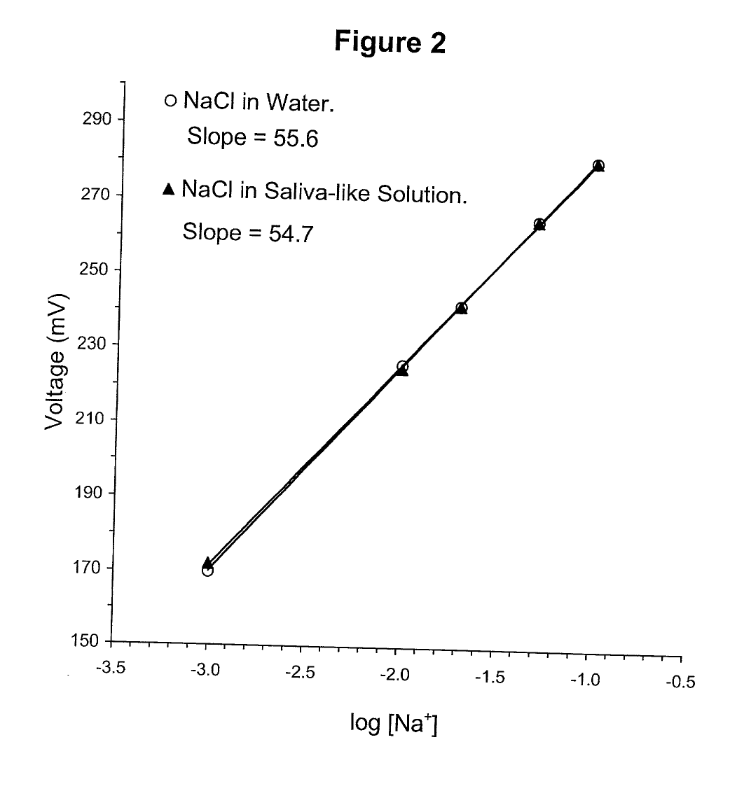

Examples of electrodes 10 according to the present invention were prepared according to method 20 and used for the determination of ionic concentrations in solution. Electrodes 10 exhibited accurate calibration curves and high selectivity as detailed hereinbelow and illustrated by FIGS. 2-8. Electrodes 10 are characterized by improved stability of potential, short response time, and confirmed long-term durability. Further, they are inexpensive, amenable to manufacture in relatively small dimensions and producible by simplified methods 20 which are suitable for large-scale manufacture.

According to various preferred embodiments of electrode 10, internal reference 5 includes a homogenous conductive material, e.g. a carbon body or a metal wire. It will be appreciated that other homogenous conductors are acceptable as electric indication elements and that use thereof would not substantially alter electrode 10. The intrinsic stability of potential of electrode 10 eliminates the need for further stabilization, which is typically commonly done by formation of a redox couple in prior art teachings[5, 6, 7, 9]. Elimination of the requirement for chemical or electrochemical coating of reference element 5 significantly reduces production costs of electrode 10.

According to method 20, solid contact 7 and membrane 8 are both preferably created by spontaneous evaporation of a volatile organic solvent at room temperature. Additional steps such as heating, adhesion or mechanical connection are unnecessary. Thus method 20 is shorter and simpler than prior art manufacture procedures of ISEs with hydrophobic solid contacts [8, 9]. Elimination of the need for anodizing or coating a wire, heat treatment, dipping process of several hours, adhesion or mechanical connection of inner parts represents novelty with respect to prior art teachings and gives significant added utility to methods 20 with respect to those teachings. Method 20 is especially suitable for large-scale industrial production.

Method 20 may be employed to produce ISFETs by using a semiconductor instead of a conductor as reference element 5. Additionally, the use of liquid phase raw materials (emulsions and solutions) in the formation of both solid contact and membrane makes method 20 ideally suited for use in forming electrodes with complex geometries which were difficult to construct using prior art methods.

The total dimensions of constructed tubular electrodes 10 described hereinbelow as examples were 8 mm length and 3 mm diameter. This compares favorably with the dimensions of a typical commercial ISE (Metrohm 6.0504.110 potassium selective electrode), which are 161 mm length and 12 mm diameter. It is anticipated that further miniaturization using method 20 is achievable and such further miniaturization is included within the scope of the present invention.

In summary, electrodes 10 are possessed of unique and desirable properties which make them ideally suitable for applications including, but not limited to, medical analyzers for POC and home use.

### EXAMPLES

Reference is now made to the following examples, which together with the above descriptions illustrate the invention in a non-limiting fashion.

Examples of electrode 10 were prepared and tested. Specifically, three kinds of ISEs 10 were prepared and examined—for Na⁺, K⁺ and Li⁺ respectively. Their structure (FIG. 1) was similar, and only the specific chemical composition of the membrane and the solid contact was different for each ion (e.g. the ionophore identity). It is stressed these are only examples of electrode 10, and that additional sensors, such as those with specificity for additional ions, can be made using the same technology by varying the choice of ionophores and chemical additives. Such additional sensors are specifically included within the scope of the present invention.

### Example 1

### Preparation of Electrodes

Electrode 10 was constructed of polyethylene tube 1, with a 3 mm internal diameter and 7 mm length. Tube 1 was open from one side and closed from the other side, except for a central small hole 2 (1 mm diameter). Stripped end 3 of a shielded electric wire 4 was inserted into hole 2. Reference element 5 was a cylindrical rod of compressed graphite, with 3 mm diameter and 4 mm length. Reference element 5 was mounted tightly in polyethylene tube 1, so electric contact was formed with stripped end 3 of wire 4. This formed cylindrical space 6 inside tube 1 which constitutes the electrode body. Within space 6, solid contact 7 (2 mm thickness) and selective membrane 8 (1.5 mm thickness) were produced using method 20 and the materials listed below, to complete the electrode structure. ISE 10 was connected by means of shielded wire 4 to a commercially available voltmeter. Potentiometric measurements were done versus a standard reference electrode (Ag/AgCl), which was also connected to the voltmeter and immersed in the test solution.

All materials that were used in the preparation of membranes and solid contacts were purchased from Fluka Ltd., and were applied without prior treatment.

The membrane mixtures were composed of the following chemicals: PVC—high molecular weight; THF (≧99.5% by GC); 2-nitrophenyl octyl ether; bis(1-butylpentyl) adipate potassium; and tetrakis(4-chlorophenyl) borate.

In addition, the following ion carriers were incorporated in the membrane formulas: Sodium Ionophore X (4-tert-butylcalix(4)arene-tetraacetic acid tetraethyl ester) for Na⁺; Potassium Ionophore III (2-dodecyl-2-methyl-1,3-propandiyl bis(N-(5′-nitro(benzo-15-crown-5)-4′-yl)carbamate)) for K⁺; and Lithium Ionophore VIII (N,N,N′,N′,N″,N″-hexacyclohexyl-4,4′,4″-propylidynetris(3-oxabutyramide)) for the (Li⁺) electrodes.

The solid contacts contained the same ingredients as the membranes with the supplement of graphite powder.

Experimental results are presented hereinbelow to demonstrate the utility of various embodiments of ISEs 10 according to the present invention. Potentiometric measurements were performed against an Ag/AgCl reference electrode (Metrohm 6.0726.100, Herisau, Switzerland) using a Metrohm 692 pH/Ion Meter.

### Example 2

### Calibration Curves and Sensitivity

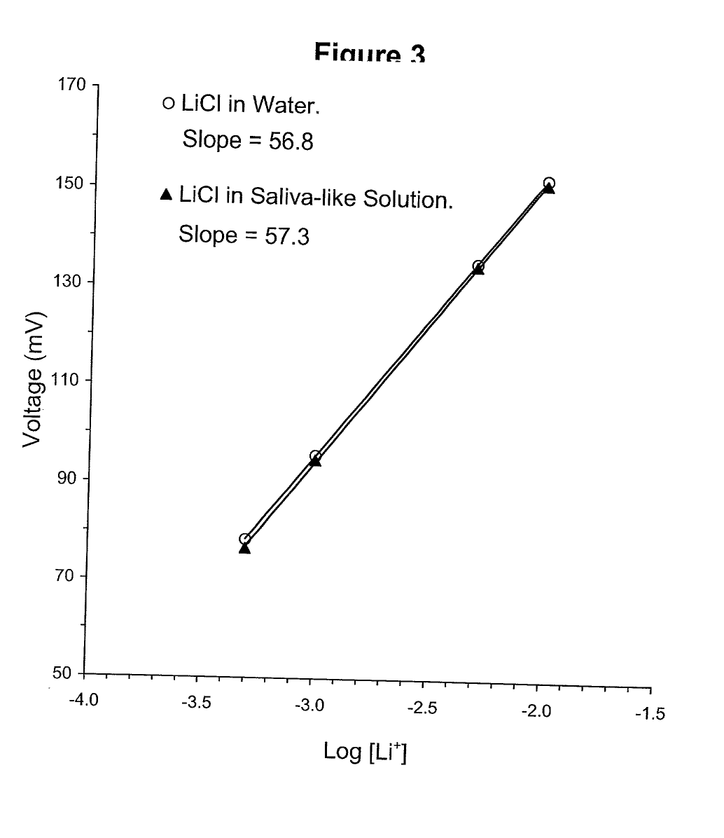

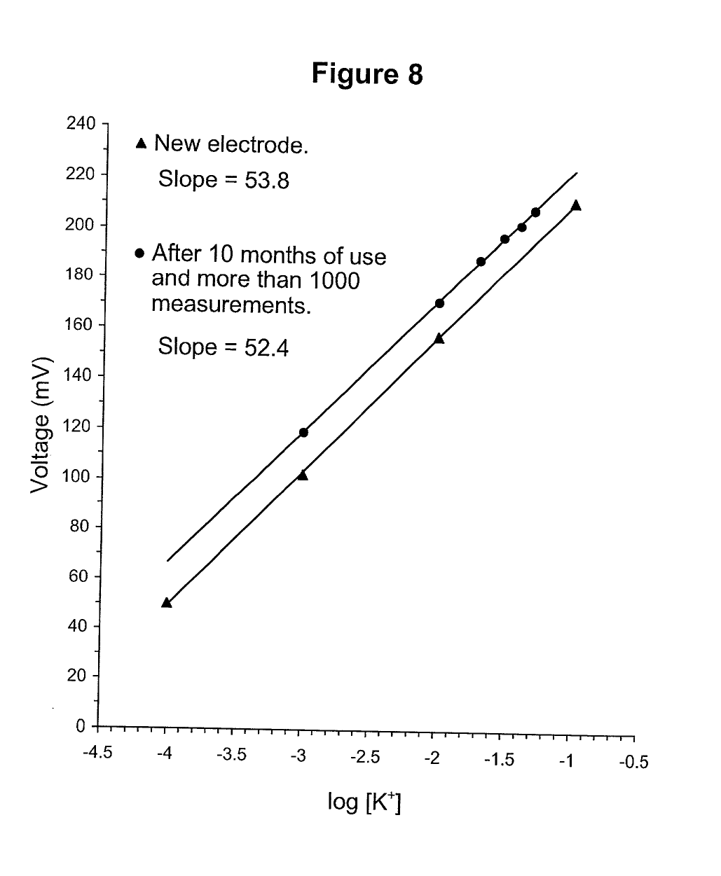

Representative calibration curves for Na⁺, Li⁺and K⁺ electrodes are presented in FIGS. 2, 3 and 8, respectively. ISEs according to the present invention demonstrate remarkable linearity in the tested concentration ranges. A sodium electrode according to the present invention was tested in the 1-100 mEq/L Na⁺ range (FIG. 2). A lithium electrode according to the present invention was tested in the 0.5-10 mEq/L Li⁺ (FIG. 3). A potassium electrode according to the present invention was tested in the 0.1-100 mEq/L K⁺ (FIG. 8). For each tested electrode, the results indicate that the linear range includes the concentrations of interest for clinically relevant applications. For example, the serum Li⁺ level of lithium treated patients and the physiological concentrations of Na⁺ and K⁺ are included in the linear ranges of the tested electrodes.

Slopes of 55.6, 56.8 and 53.8 mV/decade were recorded for Na⁺, Li⁺ and K⁺, respectively, in water. These values represent accepted sensitivity levels of ISEs and are sufficiently close to the theoretical slope according to the Nernst equation (58 mV/decade at 20° C.).

### Example 3

### Selectivity

The selectivity of electrodes according to the present invention is demonstrated in FIGS. 2, 3 and 4. In FIGS. 2 and 3 calibration curves for Na⁺ and Li⁺, respectively, were almost identical in water and in artificial saliva solution. The artificial saliva solution contained 18 mEq/L KCl, 2.9 mEq/L CaCl₂, 0.6 mEq/L MgCl₂. In the case of the Li⁺ measurements, 10 mEq/L of NaCl was further included in the artificial saliva solution. The results indicate that the tested electrodes are selective sensors, which can be used in physiological media including, but not limited to saliva.

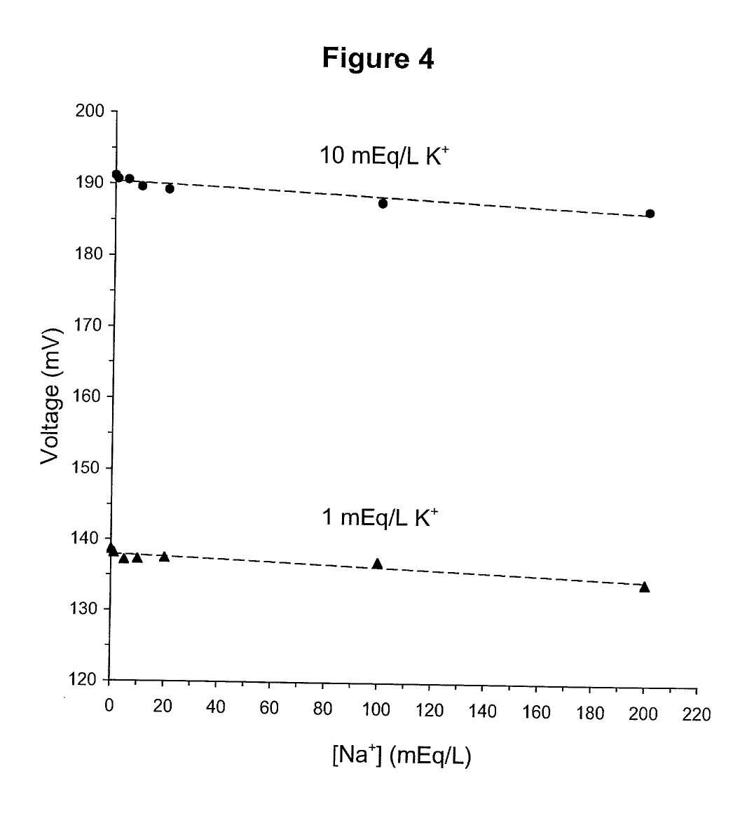

The selectivity of the K⁺ electrode is depicted in FIG. 4. Gradual addition of NaCl, up to 200 mEq/L, caused voltage changes of less than 5 mV, in the measurement of 1 and 10 mEq/L KCl. This result indicates high K⁺: Na⁺ selectivity. The demonstrated sensitivity is satisfactory for the detection of potassium in blood and other physiologic solutions.

### Example 4

### Response Time

All tested ISEs according to the present invention exhibit response times of 10-15 sec from immersion in a solution containing an ion to be detected (1 mEq/L) until full stabilization of the voltage (±1 mV). Such a response time is suitable for settings that require rapid measurement, such as non-laboratory medical applications.

### Example 5

### Stability of Potential and Long-term Durability

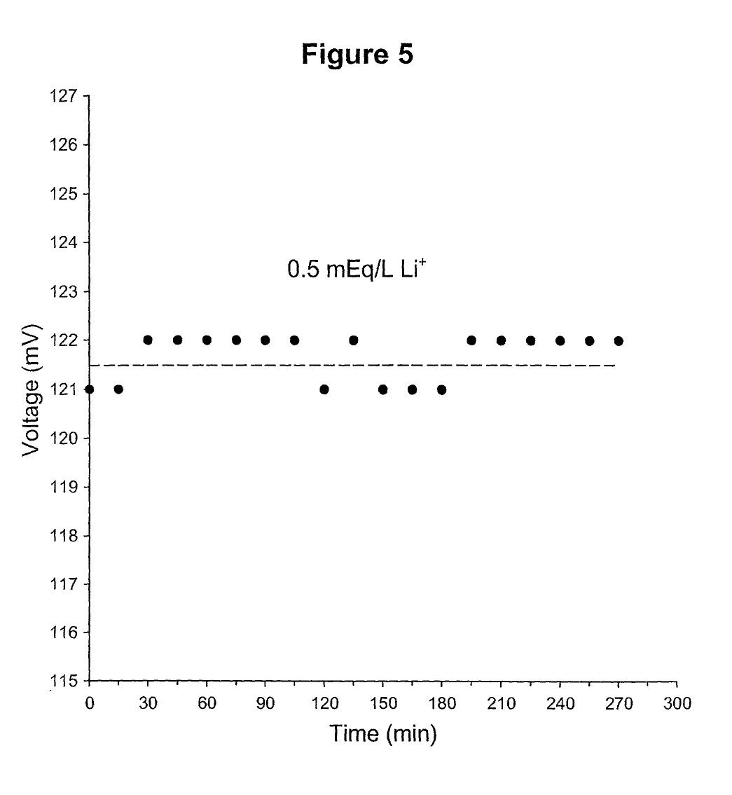

In order to demonstrate stability of electrodes according to the present invention, continuous measurement of 0.5 mEq/L LiCl solution using a lithium electrode was undertaken. An almost constant potential, of 121-122 mV, was recorded every 15 min during 4.5 hours (FIG. 5). Therefore, in continous short-term use, electrodes according to the present invention exhibit highly stable potential.

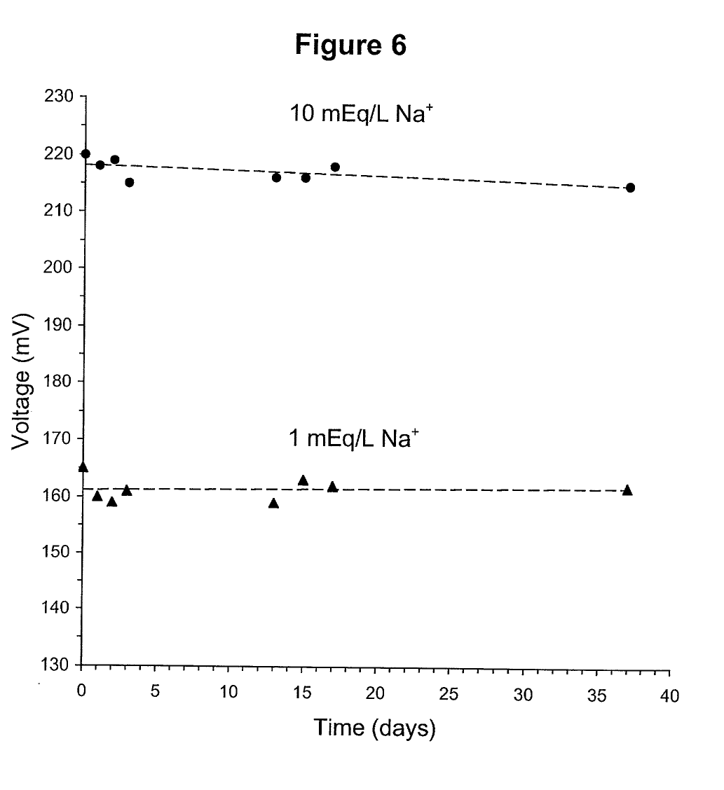

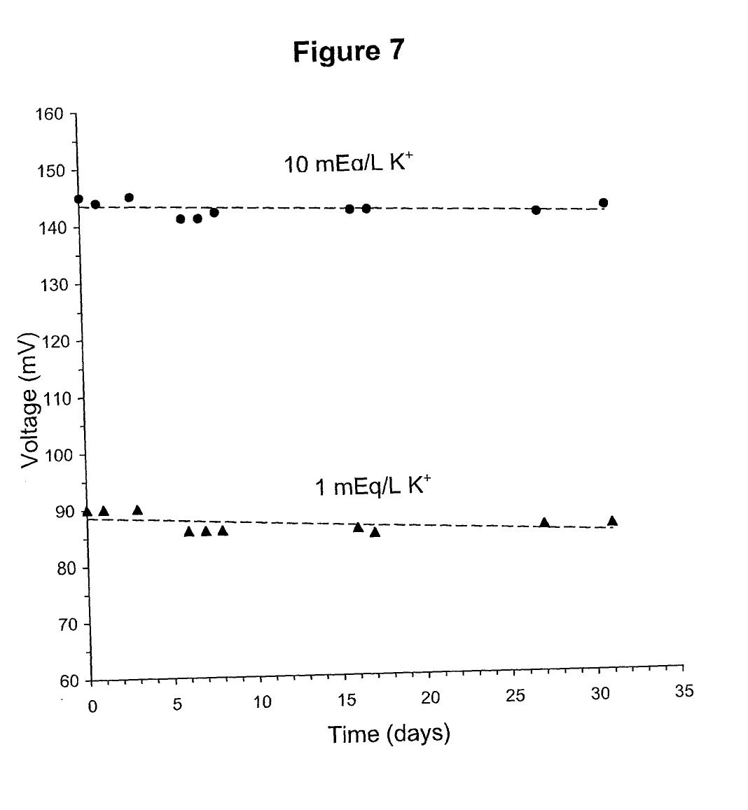

The stability of potential over longer periods of time of electrodes according to the present invention is illustrated in FIGS. 6 and 7. Drift values of less than 4 mV were recorded during over 30 days in the detection of 1 and 10 mEq/L Na⁺ (FIG. 6) and K⁺ (FIG. 7) using electrodes with specificities to those ions.

In order to further demonstrate durability of the potassium electrode (FIG. 8) a trial spanning ten months and more than 1000 measurements was undertaken. The tested ISE was still functional and exhibited a fine calibration curve at the end of this study. Results after 10 months were similar to the curve recorded with the same electrode immediately after its production. When measuring the concentration of 1 mEq/L K⁺, the potential changed only 17 mV during the ten months (i.e. avarage drift rate of 1.7 mV/month). The long-term stability of potential reflected in these results is higher than that reported in prior art [4, 5, 9]. The period of ten months is considered as rather long, since, for example, the average duration of standard commercial ISEs (Metrohm electrodes, e.g. 6.0504.110) is ca. 6 months according to their instructions of use. As mentioned earlier, stability of potential and overall durability of an ISE are key features in modem practice such as POC and home-use analyzers.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

### REFERENCES

1. For instance: (a) Greenberg, A., “Diuretic Complications”, Am. J Med. Sci. 2000, 319, 10-24 (b) Jafferson, J. W., “Lithium: The Present and the Future”, J. Clin. Psychiatry 1995, 56, 41-48.

2. For a general review, see: Meyerhoff, M. E. and Opdycke, W. N., “Ion Selective Electrodes”, Adv. Clin. Chem. 1986, 25, 1-47.

3. St-Louis, P., “Status of Point-of-Care Testing: Promise, Realities and Possibilities”, Clin. Biochem. 2000, 33, 427-440.

4. U.S. Pat. No. 5,584,979.

5. U.S. Pat. No. 5,897,758.

6. U.S. Pat. No. 3,856,649.

7. U.S. Pat. No. 4,653,499.

8. U.S. Pat. No. 5,417,836.

9. U.S. Pat. No. 5,840,168.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. An improved solid-state ion selective electrode, the electrode comprising:
(a) an internal reference element, said reference element comprising a single homogenous conducting body;
(b) a solid contact, said solid contact comprising a first hydrophobic polymer, a first ionophore of an ion to be detected and a non-ordered plurality of particles of conductive material, wherein said particles of conductive material are dispersed throughout said first hydrophobic polymer; and
(c) an ion selective membrane, said ion selective membrane comprising a second hydrophobic polymer and a second ionophore of said ion to be detected.

2. The electrode of claim 1, wherein said solid contact further comprises a solid contact plasticizer.

3. The electrode of claim 2, wherein said solid contact plasticizer is selected from the group consisting of 2-nitrophenyl octyl ether and bis(1-butylpentyl) adipate.

4. The electrode of claim 1, wherein said membrane further comprises a membrane plasticizer.

5. The electrode of claim 4, wherein said membrane plasticizer is selected from the group consisting of 2-nitrophenyl octyl ether and bis(1-butylpentyl) adipate.

6. The electrode of claim 1, wherein at least one item selected from the group consisting of said solid contact and said membrane further comprises at least one additive.

7. The electrode of claim 6, wherein said at least one additive includes potassium tetrakis-(4-chlorophenyl) borate.

8. The electrode of claim 1, wherein said homogenous conductive body includes a compressed graphite rod.

9. The electrode of claim 1, wherein at least one item selected from the group consisting of said first hydrophobic polymer and said second hydrophobic polymer includes polyvinylchloride (PVC).

10. The electrode of claim 1, wherein said ion to be detected is selected from the group consisting of sodium (Na⁺), potassium (K⁺) and lithium (Li⁺).

11. The electrode of claim 1, wherein said first ionophore and said second ionophore are selected from the group consisting of the sodium ionophore 4-tert-butylcalix(4)arene-tetraacetic acid tetraethyl ester, the potassium ionophore 2-dodecyl-2-methyl-1,3-propandiyl bis(N-(5′-nitro(benzo-15-crown-5)-4′-yl)carbamate, and the lithium ionophore N,N,N′,N′,N″,N″-hexacyclohexyl-4,4′,4″-propylidynetris(3-oxabutyramide).

12. The electrode of claim 1, wherein said conductive material includes graphite, and wherein said particles of said conductive material include graphite powder.

13. A method of producing an improved solid-state ion selective electrode, the method comprising the steps of:
(a) providing an internal reference element, said reference element comprising a single homogenous conducting body;
(b) preparing a homogenous emulsion, said emulsion comprising a first hydrophobic polymer, a first ionophore of an ion to be detected, a plurality of particles of conductive material, and a first organic solvent;
(c) applying said homogeneous emulsion to a surface of said reference element and allowing said first organic solvent to evaporate thereby causing a residue of said homogeneous emulsion to form a solid contact adhering to at least a portion of said reference element;
(d) preparing a homogenous solution, said solution comprising a second hydrophobic polymer, a second ionophore of said ion to be detected and a second organic solvent; and
(e) applying said solution to at least a portion of said solid contact and allowing said second organic solvent to evaporate to form an ion selective membrane adhering to at least a portion of said solid contact.

14. The method of claim 13, further including the step of:
(f) placing a stripped end of a shielded electric wire within a plastic tube, said plastic tube functioning as the electrode body.

15. The method of claim 14, further including the step of:
(g) tightly inserting said homogenous conductive body of said reference element into said plastic tube so that an electric contact with said stripped end of said shielded electric wire is formed.

16. The method of claim 15, wherein said step of applying said homogeneous emulsion to said surface of said reference element is conducted within said plastic tube so that said solid contact is formed therein.

17. The method of claim 16, wherein said step of applying said homogeneous solution to said surface of said solid contact is conducted within said plastic tube so that said membrane is formed therein.

18. The method of claims 13, wherein at least one item selected from the group consisting of said first organic solvent and said second organic solvent is tetrahydrofurane (THF).

19. The method of claim 13, wherein said step of allowing said first organic solvent to evaporate and said step of allowing said second organic solvent to evaporate are each independently conducted at a low temperature.

20. The method of claim 19, wherein said low temperature is in the range of 14 to 28 degrees centigrade.

21. The method of claim 13, wherein said single homogeneous conducting material comprises graphite.

22. The method of claim 13, wherein said emulsion further comprises a solid contact plasticizer.

23. The method of claim 22, wherein said solid contact plasticizer is selected from the group consisting of 2-nitrophenyl octyl ether and bis(1-butylpentyl) adipate.

24. The method of claim 13, wherein said solution further comprises a membrane plasticizer.

25. The method of claim 24, wherein said membrane plasticizer is selected from the group consisting of 2-nitrophenyl octyl ether and bis-(1-butylpentyl) adipate.

26. The method of claim 13, wherein at least one item selected from the group consisting of said emulsion and said solution further comprises at least one additive.

27. The method of claim 26, wherein said at least one additive includes potassium tetrakis(4-chlorophenyl) borate.

28. The method of claim 13, wherein at least one item selected from the group consisting of said first hydrophobic polymer and said second hydrophobic polymer includes polyvinylchloride (PVC).

29. The method of claim 13, wherein said ion to be detected is selected from the group consisting of sodium (Na⁺), potassium (K⁺) and lithium (Li⁺).

30. The method of claim 13, wherein said first ionophore and said second ionophore are selected from the group consisting of the sodium ionophore 4-tert-butylcalix(4)arene-tetraacetic acid tetraethyl ester, the potassium ionophore 2-dodecyl-2-methyl-1,3-propandiyl bis(N-(5′-nitro(benzo-15-crown-5)-4′-yl)carbamate, and the lithium ionophore N,N,N′,N′,N″,N″-hexacyclohexyl-4,4′,4″-propylidynetris(3-oxabutyramide).

31. The method of claim 13, wherein said conductive material includes graphite, and wherein said particles of said conductive material include graphite powder.
